(19) United States
(12) Patent Application Publication
(10) Pub. No.: US 2017/0293579 A1
(43) Pub. Date: Oct. 12, 2017

(54) INFORMATION TRANSMISSION APPARATUS AND INFORMATION TRANSMISSION METHOD

(71) Applicant: SONY CORPORATION, TOKYO (JP)

(72) Inventors: YOICHIRO SAKO, TOKYO (JP); MASAKAZU YAJIMA, CHIBA (JP); TAKAYUKI HIRABAYASHI, TOKYO (JP); MASASHI TAKEDA, TOKYO (JP); KOUICHIROU ONO, TOKYO (JP)

(21) Appl. No.: 15/511,762

(22) PCT Filed: Jun. 26, 2015
(86) PCT No.: PCT/JP2015/068587

§ 371 Date: Mar. 16, 2017

(30) Foreign Application Priority Data
Sep. 24, 2014 (JP) 2014-193626

(51) Int. Cl. G06F 13/364; G06F 13/42; G06F 13/40

(52) U.S. Cl. CPC G06F 13/364; G06F 13/4018; G06F 13/4282; G06F 13/404

(57) ABSTRACT

There is provided an information transmission apparatus and an information transmission method for suitably transmitting information on power generation or power storage. A unified format of a message is provided to various power generation devices or power storage devices, which may be connected to various apparatuses for outdoor use that cannot use a commercial power supply, such as portable electronic apparatuses, the message transmitting information on a power generation efficiency and other power generation statuses, and the remaining amount, a power storage efficiency, and other power storage statuses of the secondary battery. The electronic apparatus, which uses electric power from the power generation devices or power storage devices, analyzes the message from any of the power generation devices or power storage devices and presents a result to a user.

### TECHNICAL FIELD

The technology disclosed in this specification relates to an information transmission apparatus that transmits information on power generation or power storage, and to an information transmission method therefor.

Various portable information devices, e.g., multifunctional portable terminals such as a smartphone and a tablet, a digital camera, and a portable music player, are widely used. The majority of such types of information devices is of a battery-driven type, in which an operation time is determined according to the remaining amount of the battery, and replacement or charge of the battery is necessary.

For example, an apparatus for displaying a battery remaining amount is proposed, which can visualize how long a user can use a device or function in relation to a battery remaining amount (see, for example, Patent Literature 1).

Further, a battery remaining amount display method is proposed, in which a battery loss amount indicator is constituted by disposing in line three segments of dual color LED (light-emitting diode) in which green and red LEDs are accommodated in one package (see, for example, Patent Literature 2).

Further, a display apparatus is proposed, in which two parameters of a shape and a display color of a battery remaining amount icon are changed to simultaneously display the remaining amount of two batteries in a display region corresponding to one battery remaining amount icon (see, for example, Patent Literature 3).

Further, a battery remaining amount detection apparatus is proposed, which detects the voltage of a secondary power supply and informs a user of the remaining amount of the secondary power supply accurately at the most appropriate timing (see, for example, Patent Literature 4).

Further, a power generation apparatus is proposed, with which a user can unconsciously generate electric power through daily actions of human beings, such as walking (see, for example, Patent Literatures 5 and 6). The power generation apparatus is provided to shoes worn by the user. Since the body weight of the user is used as a weight from the outside, power generation can be performed by, for example, walking or running of daily life, so that a practical power generation apparatus can be provided. Using electric power obtained with this type of power generation apparatus, a portable device can be driven or power can be stored in a secondary battery.

Further, an apparatus for energy harvesting with sunlight, vibration, heat, or environmental electromagnetic waves being used as energy source is also proposed (see, for example, Patent Literature 7).

A user of a power generation apparatus or power storage apparatus needs to perform an operation of checking whether a secondary battery has a sufficient amount of power storage. If the user knows that the amount of power storage is sufficient, the user can detach the storage battery from the power generation apparatus and replace the storage battery with a secondary battery of an information device being used by the user or carry out the storage battery as a spare battery.

When the secondary battery charged in the power generation apparatus or power storage apparatus is used, it is necessary to check the amount of power storage thereof. When the amount of power storage is insufficient, an action of replacing the battery goes to waste. Especially, when the power generation apparatus is provided to the outside (shoes worn by the user, etc.) of an information device, the information device does not have means of directly acquiring information on the amount of power storage of the secondary battery of the power generation apparatus.

### CITATION LIST

### Patent Literature

Patent Literature 1: Japanese Patent Application Laid-open No. Hei 11-223666

Patent Literature 2: Japanese Patent Application Laid-open No. 2005-164250

Patent Literature 3: Japanese Patent Application Laid-open No. 2009-103564

Patent Literature 4: Japanese Patent Application Laid-open No. 2001-215262

Patent Literature 5: Japanese Patent Application Laid-open No. 2008-301606

Patent Literature 6: Japanese Patent Application Laid-open No. 2007-330034

Patent Literature 7: Japanese Patent Application Laid-open No. 2002-118480

Patent Literature 8: WO2014/041872

### DISCLOSURE OF INVENTION

### Technical Problem

It is an object of the technology disclosed in this specification to provide an optimal information transmission apparatus and an optimal information transmission method that are capable of suitably transmitting information on power generation or power storage.

### Solution to Problem

The technology disclosed in this specification have been made in consideration of the above problems, and according to a first aspect thereof, there is provided an information transmission apparatus including: an information acquisition unit that acquires power generation/power storage information of a power generation unit or a power storage unit; a message generation unit that generates a message having the predetermined format containing the power generation/power storage information; and a communication unit that transmits the message.

According to a second aspect of the technology disclosed in this specification, the information transmission apparatus according to the first aspect further includes a power generation unit or a power storage unit. The information acquisition unit is configured to monitor the power generation unit or the power storage unit and acquire power generation/power storage information.

Further, according to a third aspect of the technology disclosed in this specification, there is provided an information transmission apparatus including: a communication unit that receives a message having a predetermined format containing power generation/power storage information of a power generation unit or a power storage unit; and an information analysis unit that analyzes the received message.

According to a fourth aspect of the technology disclosed in this specification, the information transmission apparatus according to the third aspect further includes: a presentation unit; and a presentation control unit that controls the presentation unit to present the power generation/power storage information on the basis of an analysis result by the information analysis unit.

According to a fifth aspect of the technology disclosed in this specification, in the information transmission apparatus according to the fourth aspect, when the received message contains power generation information and power storage information, the presentation control unit is configured to control the presentation unit to present the power generation information and the power storage information, when the received message contains only the power generation information, the presentation control unit is configured to control the presentation unit to present the power generation information, and when the received message contains only the power storage information, the presentation control unit is configured to control the presentation unit to present the power storage information.

According to a sixth aspect of the technology disclosed in this specification, in the information transmission apparatus according to the fourth aspect, when pieces of power generation/power storage information are received, the presentation control unit is configured to add the pieces of power generation/power storage information and control the presentation unit to present a result.

According to a seventh aspect of the technology disclosed in this specification, in the information transmission apparatus according to the fourth aspect, when pieces of power generation/power storage information are received, the presentation control unit is configured to normalize each of the pieces of power generation/power storage information by the maximum or prescribed generated electric power or by the amount of generated electric power or a charging capacity, and control the presentation unit to present a result.

According to an eighth aspect of the technology disclosed in this specification, in the information transmission apparatus according to the fourth aspect, when pieces of power generation/power storage information are received, the presentation control unit is configured to present a list of the pieces of power generation/power storage information, or select one of the pieces of power generation/power storage information and present the selected piece of power generation/power storage information.

Further, according to a ninth aspect of the technology disclosed in this specification, there is provided an information transmission method including: an information acquisition step of acquiring power generation/power storage information of a power generation unit or a power storage unit; a message generation step of generating a message having the predetermined format containing the power generation/power storage information; and a communication step of transmitting the message.

Further, according to a tenth aspect of the technology disclosed in this specification, there is provided an information transmission method including: a communication step of receiving a message having a predetermined format containing power generation/power storage information of a power generation unit or a power storage unit; and an information analysis step of analyzing the received message.

### Advantageous Effects of Invention

According to the technology disclosed in this specification, it is possible to provide an optimal information transmission apparatus and an optimal information transmission method that are capable of suitably transmitting information on power generation or power storage.

It should be noted that the effects described in this specification are merely illustrative and not necessarily limited to those described above. Further, the present invention may produce further additional effects in addition to the effects described above.

Other objects, features, and advantages of the technology disclosed in this specification will become apparent from more detailed description in conjunction with the following embodiments and the accompanying drawings.

### BRIEF DESCRIPTION OF DRAWINGS

FIG. 1 is a diagram schematically showing a configuration example of an information transmission system 100 to which the technology disclosed in this specification is applied.

FIG. 2 is a diagram schematically showing a functional configuration of an information sending apparatus 200.

FIG. 3 is a diagram schematically showing a functional configuration of an information receiving apparatus 300.

FIG. 4 is a diagram exemplifying types and directions of messages between a communication unit 205 of the information sending apparatus 200 and a communication unit 301 of the information receiving apparatus 300.

FIG. 5 is a diagram showing a format example common to messages 401 to 406.

FIG. 6 is a diagram showing a structure of a category data section 504.

FIG. 7 is a flowchart showing an example of a processing operation of the information receiving apparatus 300.

FIG. 8 is a flowchart showing another example of the processing operation of the information receiving apparatus 300.

FIG. 9 is a flowchart showing still another example of the processing operation of the information receiving apparatus 300.

FIG. 10 is a diagram showing a specific example of the information transmission system 100.

FIG. 11 is a diagram showing a functional configuration of the information transmission system 100 shown in FIG. 10.

FIG. 12 is a diagram showing an internal configuration example of a head mounted display.

### MODE(S) FOR CARRYING OUT THE INVENTION

Hereinafter, an embodiment of the technology disclosed in this specification will be described in detail with reference to the drawings.

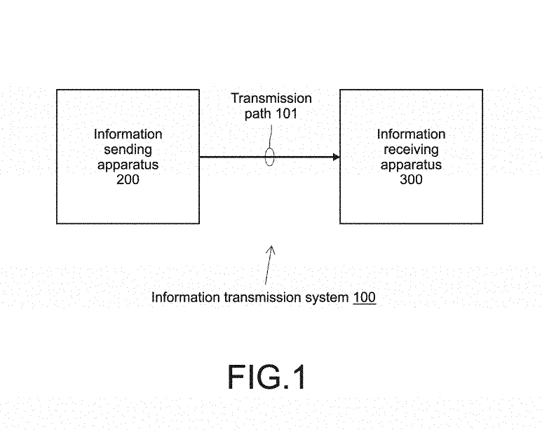

FIG. 1 schematically shows a configuration example of an information transmission system 100 to which the technology disclosed in this specification is applied. The information transmission system 100 shown in the figure includes an information sending apparatus 200 that sends information on power generation or power storage, and an information receiving apparatus 300 that receives information on power generation or power storage.

The information sending apparatus 200 includes various power generation devices or power storage devices, which may be connected to various apparatuses for outdoor use that cannot use a commercial power supply, such as portable electronic apparatuses. The information sending apparatus 200 is, for example, a power generation apparatus or power storage apparatus that performs power generation by shoes, energy harvesting, or the like.

Further, the information receiving apparatus 300 is an information device that consumes generated or stored electric energy. The information device includes various apparatuses for outdoor use that cannot use a commercial power supply, such as portable electronic apparatuses. Specifically, examples of the information device include a head mounted display, multifunctional portable terminals such as a smartphone and a tablet, a personal computer, a digital camera, a digital video camera, an electronic book, a portable music player, a game machine, a watch, a watch-type electronic apparatus, a sports sensor, and a controller thereof.

The information sending apparatus 200 and the information receiving apparatus 300 are connected to each other via a transmission path 101. A communication interface system applied to the transmission path 101 may be any of wired and wireless forms. Examples of a communication standard described herein include MHL (Mobile High-definition Link), USB (Universal Serial Bus), HDMI (registered trademark) (High Definition Multimedia Interface), Wi-Fi (registered trademark), Bluetooth (registered trademark) communication, BLE (Bluetooth (registered trademark) Low Energy) communication, ANT, and wireless communication of super-low power consumption such as EnOcean (registered trademark) Alliance, infrared communication such as UART, intra-body communication, and signal transmission via a conductive fiber.

It should be noted that for simplification of the figure FIG. 1 shows one information sending apparatus 200 and one information receiving apparatus 300, but the following use mode is also assumed: one information receiving apparatus 300 sends and receives information on power generation or power storage to and from a plurality of information sending apparatuses 200 (i.e., a plurality of power generation apparatuses or power storage apparatuses).

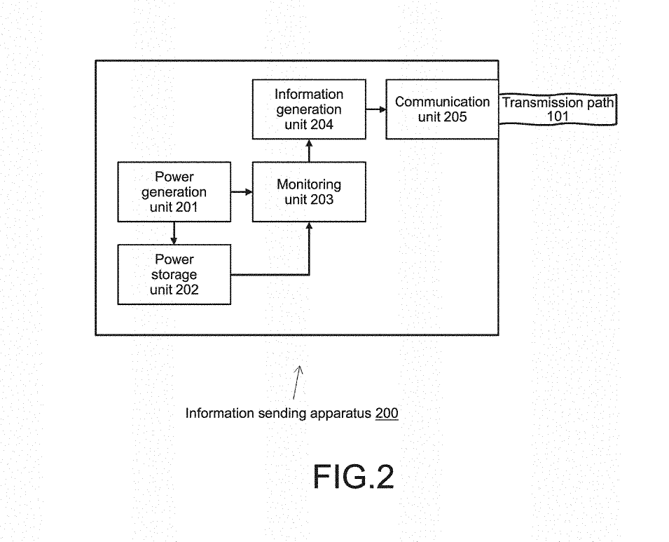

FIG. 2 schematically shows a functional configuration of the information sending apparatus 200. The information sending apparatus 200 shown in the figure includes a power generation unit 201, a power storage unit 202, a monitoring unit 203, an information generation unit 204, and a communication unit 205.

The power generation unit 201 performs power generation by kinetic energy or energy harvesting with light, electromagnetic waves such as radio waves, vibration, heat, or the like being used as energy source. The power generation unit 201 then stores the obtained electric energy in the power storage unit 202. However, the principle of the power generation by the power generation unit 201 is not particularly limited. The power generation device includes a wide variety of forms, such as a solar battery, kinetic power generation, power generation by electromagnetic induction, power generation by electrostatic induction, piezoelectric power generation, and reverse magnetostrictive power generation. Further, the solar battery includes an Si-based solar battery, a CdTe portable battery, a Dye-sensitized solar battery, an iron sulfide based solar battery, an ultraviolet-light solar battery, an infrared-light solar battery, and the like. Further, for the power storage unit 202, a lithium-ion battery, a nickel-metal-hydride battery, a lithium-ion capacitor, an electric double-layer capacitor, an all-solid-state battery, an air battery, a combination thereof, and the like can be used. A configuration of the power storage unit 202 is not particularly limited.

The monitoring unit 203 monitors a power generation efficiency, other power generation statuses, and the like of the power generation unit 201 and monitors the remaining amount, a power storage efficiency, other power storage statuses, and the like of the power storage unit 202.

The information generation unit 204 generates transmission information to be sent to the information receiving apparatus 300, on the basis of a monitoring result or the like of the power generation unit 201 or power storage unit 202 by the monitoring unit 203, and packetizes the transmission information.

The communication unit 205 encodes and modulates an information signal to be sent to the information receiving apparatus 300, and sends the information signal to the transmission path 101.

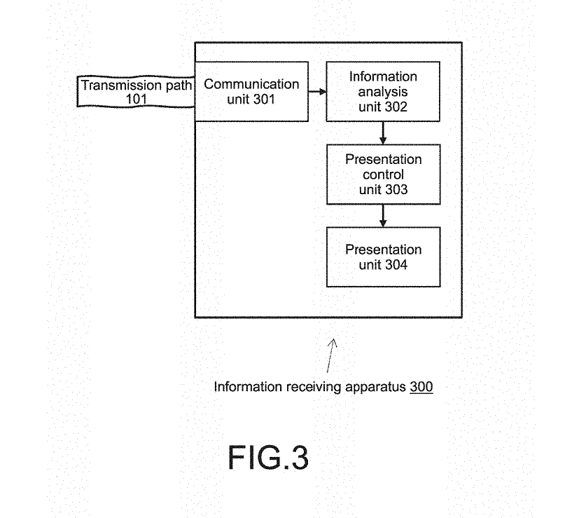

Further, FIG. 3 schematically shows a functional configuration of the information receiving apparatus 300. The information receiving apparatus 300 shown in the figure includes a communication unit 301, an information analysis unit 302, a presentation control unit 303, and a presentation unit 304.

When receiving the information signal sent from the information sending apparatus 200 via the transmission path 101, the communication unit 301 demodulates and decodes the information signal.

The information analysis unit 302 depacketizes the signal received in the communication unit 301, reproduces the information originally sent, and analyzes content thereof. In this example, the information analysis unit 302 can obtain, as analysis results of the received information, a power generation efficiency and other power generation statuses of the power generation/power storage unit 201, the remaining amount, a power storage efficiency, and other power storage statuses of the secondary battery 202, and the like.

The presentation unit 304 is constituted of a display panel and a sound output unit such as speaker. The presentation control unit 303 executes processing for presenting the power generation efficiency and other power generation statuses of the power generation unit 201, the remaining amount, the power storage efficiency, and other power storage statuses of the power storage unit 202, and the like, which are obtained in the information analysis unit 302, in the presentation unit 304 with use of an image or sound.

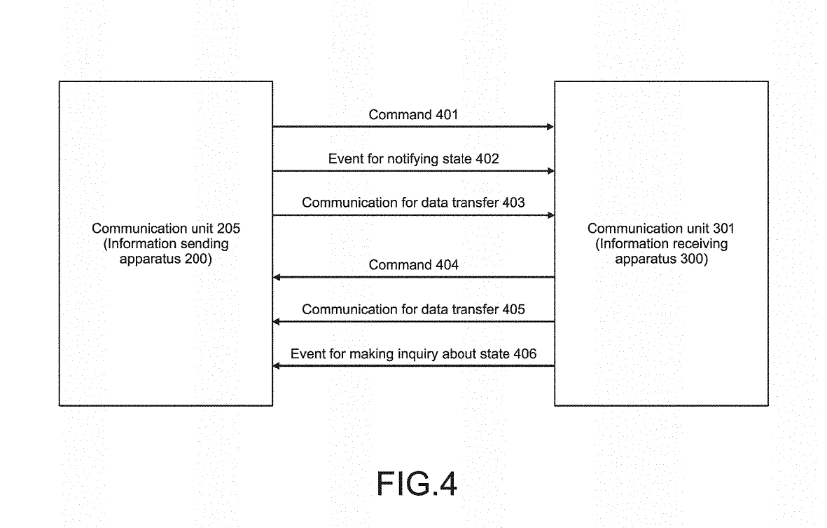

The communication unit 205 of the information sending apparatus 200 and the communication unit 301 of the information receiving apparatus 300 are connected to each other via the transmission path 101 by a predetermined communication interface system. FIG. 4 exemplifies types and directions of messages between the communication unit 205 of the information sending apparatus 200 and the communication unit 301 of the information receiving apparatus 300.

Messages from the communication unit 205 of the information sending apparatus 200 to the communication unit 301 of the information receiving apparatus 300 have three types as indicated by reference numbers 401 to 403 in FIG. 4: command, communication for data transfer, and event for notifying a change in state.

Further, messages from the communication unit 301 of the information receiving apparatus 300 to the communication unit 205 of the information sending apparatus 200 have three types as indicated by reference numbers 404 to 406 in FIG. 4: communication for data transfer, command, and event for making an inquiry about a state.

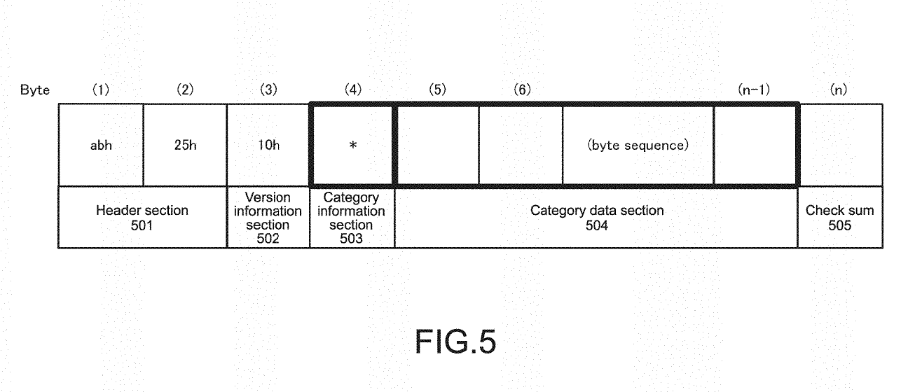

FIG. 5 shows a format example common to the messages 401 to 406. The message format shown in the figure includes a header section 501, a version information section 502, a category information section 503, a variable-length category data section 504, and a one-bite check sum 505 that is added at the tail end of the message.

With the communication message for data transfer 405, power generation/power storage information obtained by monitoring of the power generation unit 201 or the power storage unit 202 by the monitoring unit 203, and the like are transmitted from the communication unit 205 of the information sending apparatus 200. Specifically, information on a type of a power generator used in the power generation unit 201, a type of battery used in the power storage unit 202, the presence or absence of power generation, the accumulated amount of power generation, the amount of power generation per unit time, the maximum charging capacity of the power storage unit 202, the remaining amount of a power storage element, and the like are stored in the category data section 504 and then transmitted.

The determination of the message format as shown in FIG. 5 facilitates data sharing even when the information sending apparatus 200 and the information receiving apparatus 300 have differences in manufacturer, product, and model.

Further, it is assumed that the information receiving apparatus 300 that consumes generated or stored electric energy is a product applied across various industry sectors such as health, exercise, entertainment, and industrial applications. With the determination of the message format as described above, data sharing is facilitated.

Using two highest-order bits of the one-byte-length category information section 503, as shown in the following Table 1, the status of power generation or power storage is described. Further, using six lowest-order bits of the category information section 503, attribute information (type of power generator, name, mounting, etc.) of the power generation unit 201 and attribute information of the power storage unit 202 are described.

TABLE 1

| Category information section | Description |
|---|---|
| 1xxxxxxx | Power generated |
| 0xxxxxxx | No power generated |
| x1xxxxxx | Power stored |
| x0xxxxxx | No power stored |

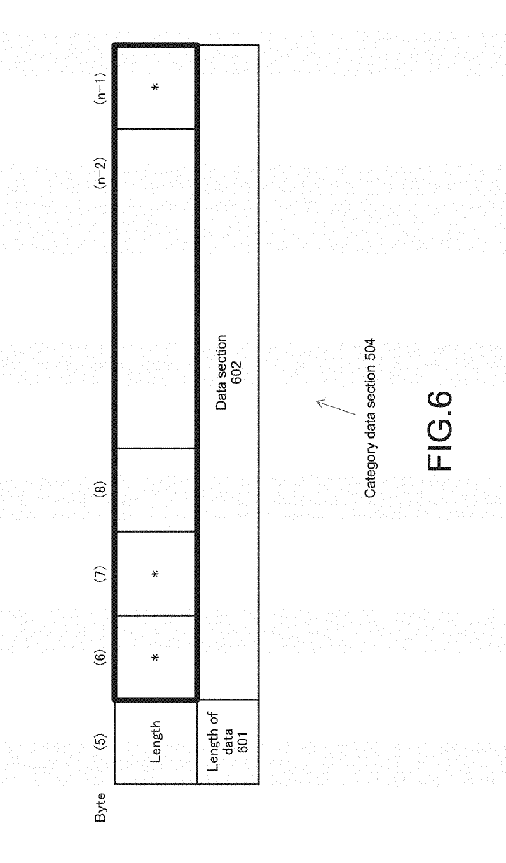

FIG. 6 shows a structure of the category data section 504. The category data section 504 is a variable-length field including a data length section (Length of data) 601 of the first byte (fifth byte from the head of the message), in which a byte count of the subsequent data section 602 (from sixth byte to (n−1)-th byte) is described.

In the case of the communication message for data transfer, by which the power generation/power storage information obtained by monitoring of the power generation unit 201 or the power storage unit 202 by the monitoring unit 203, and the like are transmitted from the communication unit 205 of the information sending apparatus 200, the power generation/power storage information is described in the data section 602 from the sixth byte to the (n−1)-th byte. Specifically, a transmission system for the power generation/power storage information, the accumulated amount of power generation (in the case of the presence of generated power, an accumulation start is set to be fixed or variable), the amount of power generation per unit time (in the case of the presence of generated power), the maximum charging capacity, and the charge remaining amount (indication of the charge remaining amount by an absolute amount or indication of the charge remaining amount by percentage) are described. It should be noted that the data section 602 may be partially used as an area where information serving as the power generation/power storage information is recorded, the information being obtained from a signal source other than a power generation element, a power storage element, and a monitoring circuit that are related to power generation and power storage. In other words, signal information from a sensor is recorded. The sensor is, for example, provided separately from this system and detects a position by, e.g., geomagnetism and GPS. With this configuration, information indicating surrounding environments at the time of power generation and power storage, such as area, location, and posture, at which the power generation or power storage is performed, may be simultaneously recorded. It should be noted that this example is not limited to a sensor that detects a location, position, or posture. The power generation/power storage information may be signals from sensors that detect temperature, humidity, radio field intensity, illuminance, chemical substance (concentration, type, state, etc.), frequency of oscillation, acceleration, force, and the like or may be complex information of those signals.

In the information sending apparatus 200, the information generation unit 204 generates a message according to the format shown in FIGS. 5 and 6 on the basis of a monitoring result or the like of the power generation unit 201 or power storage unit 202 by the monitoring unit 203, and sends the message from the communication unit 205 to the information receiving apparatus 300.

In the information receiving apparatus 300, when the message from the information sending apparatus 200 is received in the communication unit 301, the information analysis unit 302 analyzes content of the message. The presentation control unit 303 then executes processing for presenting the power generation efficiency and other power generation statuses of the power generation unit 201, the remaining amount, the power storage efficiency, and other power storage statuses of the power storage unit 202, and the like, which are obtained in the information analysis unit 302, in the presentation unit 304 with use of an image or sound.

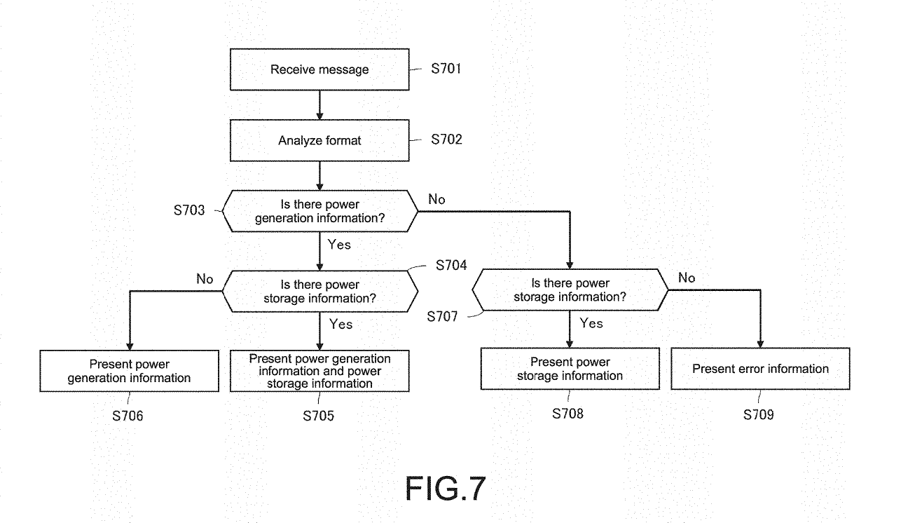

FIG. 7 shows an example of a processing operation of the information receiving apparatus 300 in the form of a flowchart.

When receiving the message from the information sending apparatus 200, the communication unit 301 performs decoding and demodulation processing (Step S701).

Subsequently, the information analysis unit 302 analyzes the format of the message (Step S702), refers to the category information section 503, and checks whether the message contains power generation information (i.e., whether the information sending apparatus 200 that is the source of the message is the power generation device) (Step S703).

When the message contains power generation information (Yes in Step S703), whether there is power storage information is further checked (Step S704). When there is power storage information (Yes in Step S704), the presentation control unit 303 is instructed to present the power generation information and the power storage information in the presentation unit 304 (Step S705). Further, when the message does not contain power storage information (No in Step S704), the presentation control unit 303 is instructed to present only the power generation information in the presentation unit 304 (Step S706).

Meanwhile, when the message does not contain power generation information (No in Step S703), whether there is power storage information is further checked (Step S707). When there is power storage information (Yes in Step S707), the presentation control unit 303 is instructed to present the power storage information in the presentation unit 304 (Step S708). Further, when the message does not contain power storage information (No in Step S707), the presentation control unit 303 is instructed to present error information in the presentation unit 304 (Step S709).

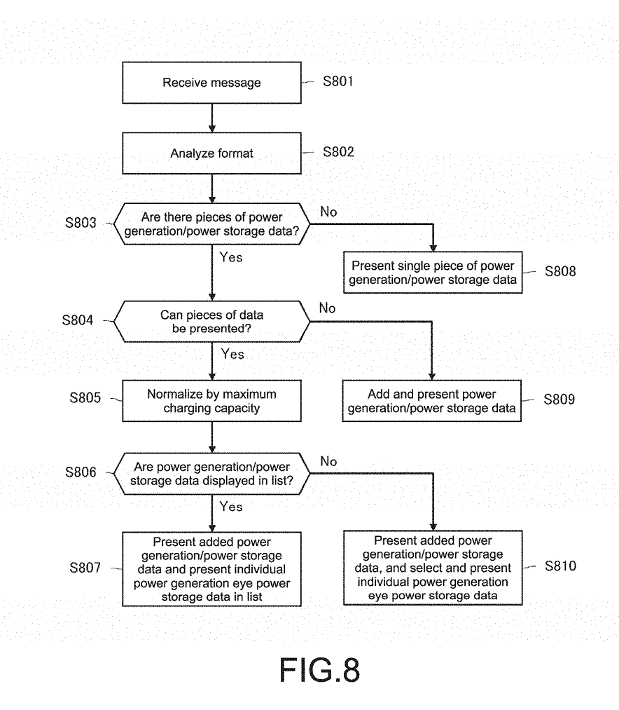

FIG. 8 shows another example of the processing operation of the information receiving apparatus 300 in the form of the flowchart. In the processing operation shown in FIG. 7, only the case where a single message is received is assumed. To the contrary, in the processing operation shown in FIG. 8, a case where a plurality of messages is simultaneously received from a plurality of information sending apparatuses 200 (i.e., a plurality of power generation devices or power storage devices) is also assumed.

When receiving the message from the information sending apparatus 200 (Step S801), the communication unit 301 performs decoding and demodulation processing, and the information analysis unit 302 analyzes the format of the message (Step S802).

Here, whether there are pieces of power generation data or power storage data is checked (Step S803).

When there is only one piece of power generation data or power storage data (No in Step S803), processing of presenting the single piece of power generation/power storage data is executed (Step S808). The processing of presenting a single piece of power generation/power storage data conforms to the processing procedure after Step S703 in FIG. 7, and detailed description thereof will be omitted here.

Meanwhile, when there are pieces of power generation data or power storage data (Yes in Step S803), it is subsequently checked whether the pieces of power generation data or power storage data can be presented in the presentation unit 304 of the information receiving apparatus 300 (Step S804).

When the pieces of power generation data or power storage data cannot be presented in the presentation unit 304 of the information receiving apparatus 300 (No in Step S804), all values of the power generation data or power storage data are added, and a result is presented in the presentation unit 304 (Step S809).

Further, when the pieces of power generation data or power storage data can be presented in the presentation unit 304 of the information receiving apparatus 300 (Yes in Step S804), a value of each piece of power generation data or power storage data is normalized by the maximum or prescribed generated electric power or by the amount of generated electric power or a charging capacity (Step S805).

When all the pieces of power generation data or power storage data are displayed in a list (Yes in Step S806), in the presentation unit 304, the added power generation data or power storage data is displayed, and the normalized individual pieces of power generation data or power storage data are displayed in a list (Step S807). Further, when all the pieces of power generation data or power storage data are not displayed in a list (No in Step S806), in the presentation unit 304, the added power generation data or power storage data is presented, and any of the normalized individual pieces of power generation data or power storage data is selected and presented (Step S810).

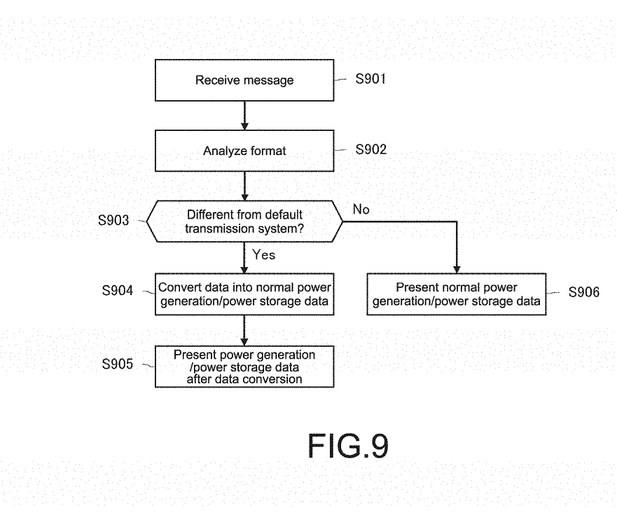

FIG. 9 shows still another example of the processing operation of the information receiving apparatus 300 in the form of the flowchart. In the processing operations shown in FIGS. 7 and 8, only the case where the message is sent from the information sending apparatus 200 by a default transmission system is assumed. To the contrary, in the processing operation shown in FIG. 9, a case where a message is sent from the information sending apparatus 200 by various transmission systems is also assumed.

When receiving the message from the information sending apparatus 200 (Step S901), the communication unit 301 performs decoding and demodulation processing, and the information analysis unit 302 analyzes the format of the message (Step S902).

Here, whether a transmission system of the message is different from the default transmission system is checked (Step S903).

When the transmission system of the message is the same as the default transmission system (No in Step S903), processing of presenting normal power generation data or power storage data is executed (Step S906). The processing of presenting the normal power generation data or power storage data conforms to the processing procedure after Step S703 in FIG. 7 or after Step S803 in FIG. 8, and detailed description thereof will be omitted here.

Meanwhile, when the transmission system of the message is different from the default transmission system (Yes in Step S903), the data is converted into normal power generation data or power storage data (Step S904), and the normal power generation data or power storage data obtained after the data conversion is presented in the presentation unit 304 (Step S905).

### Example

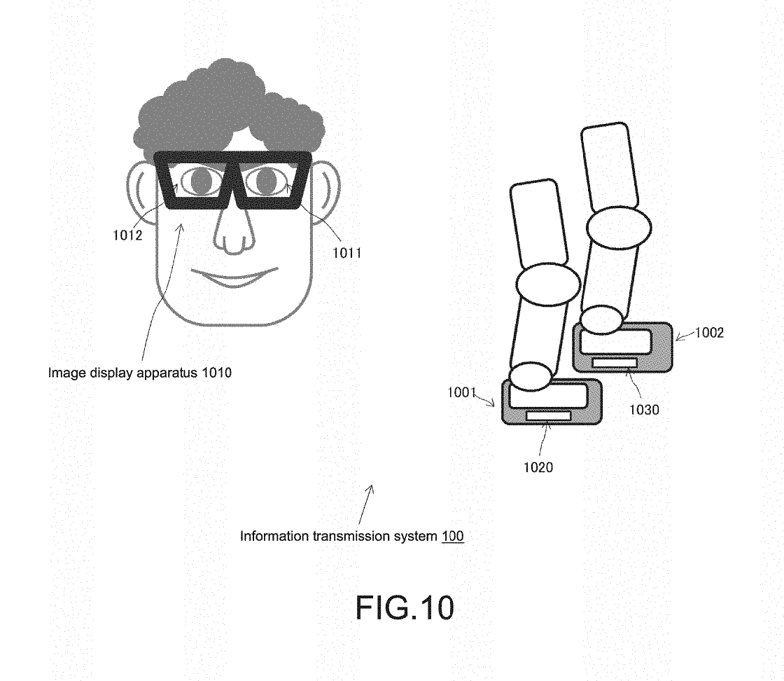

FIG. 10 shows a specific example of the information transmission system 100. The information transmission system 100 shown in the figure includes a power generation apparatus corresponding to the information sending apparatus and a head mounted display corresponding to the information receiving apparatus. The power generation apparatus includes two power generation apparatuses 1020 and 1030, which are respectively provided to shoes 1001 and 1002 for the left and right feet of a user. Further, the head mounted display is an image display apparatus 1010 worn by the user on the head or face. It should be noted that FIG. 10 shows an example in which the power generation apparatuses 1020 and 1030 are provided to both the shoes 1001 and 1002 of both the feet of the user, but as a matter of course, there may also be an example in which the power generation apparatus is provided to only one shoe of any of the right and left feet. Further, there may also be an example in which, when at least one of the right and left feet of the user is a prosthetic leg, the power generation apparatus is provided to a shoe of the prosthetic leg or the prosthetic leg itself.

Each of the power generation apparatuses 1020 and 1030 includes a power generation unit, a power storage element, and a communication unit (which are not shown in the figure). The power generation unit is constituted of a vibration- or motion-powered generator (electrostatic type, electromagnetic type, inverse magnetostriction type, piezoelectric type) that performs power generation by vibration, or a thermoelectric conversion element that performs power generation by difference in temperature. In this example, power generation according to motion of user's feet is performed. The power storage element is constituted of, for example, a capacitor, a secondary battery, a spiral spring, and a heat storage material, and stores electric power obtained by the power generation of the power generation unit or stores electric power as energy. The communication unit sends primary information to the image display apparatus 1010, the primary information containing the amount of power generation or the amount of power storage of the power generation unit. The communication unit may always operate to transfer the primary information in real time or may intermittently operate to transfer the primary information. Further, the left and right power generation apparatuses 1020 and 1030 may directly exchange data therebetween, or any one of the power generation apparatuses 1020 and 1030 may collect the amount of power generation of both the power generation apparatuses 1020 and 1030 as one piece of primary information, and collectively transfer the primary information to the image display apparatus 1010.

Meanwhile, the image display apparatus 1010 includes two display units 1011 and 1012 that respectively present a left-eye image and a right-eye image for the left and right eyes of the user. The image display apparatus 1010 displays the primary information on at least one of the left and right display units 1011 and 1012, the primary information containing the amount of power generation, the amount of power storage, and the like and being received from the power generation apparatuses 1020 and 1030. For example, the amount of power generation of the power generation apparatus 1020 provided to the shoe of the left foot may be displayed on the display unit 1011 for the left eye, and the amount of power generation of the power generation apparatus 1030 provided to the shoe of the right foot may be displayed on the display unit 1012 for the right eye.

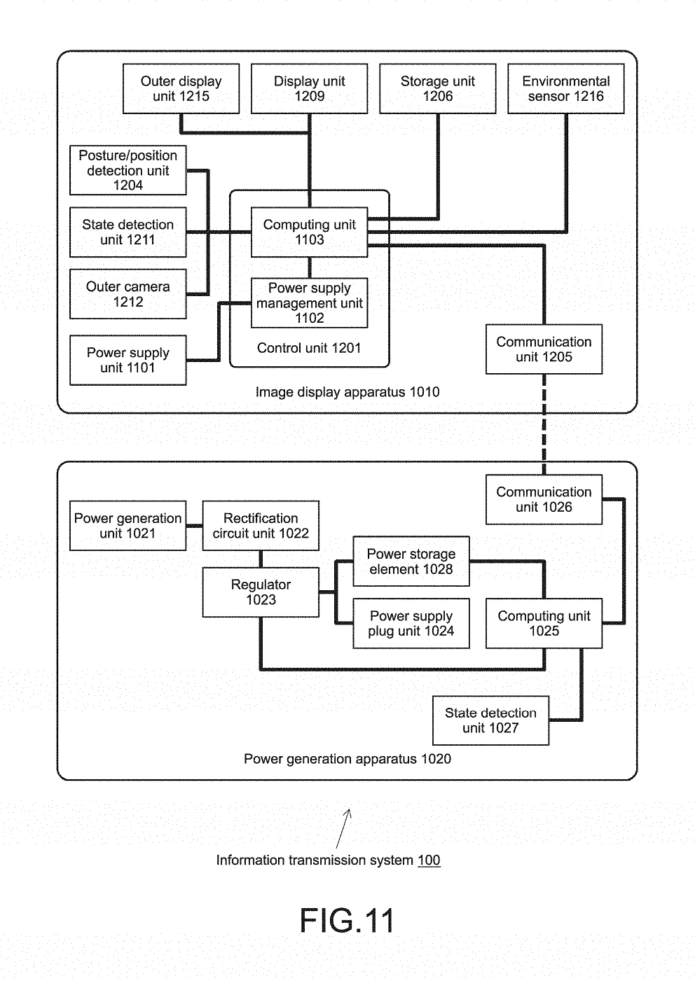

FIG. 11 shows a functional configuration of the information transmission system 100 shown in FIG. 10. However, for simplification of the figure, only one power generation apparatus 1020 is illustrated.

The power generation apparatus 1020 includes a power generation unit 1021, a rectification circuit unit 1022, a regulator 1023, a power supply plug unit 1024, a computing unit 1025, a communication unit 1026, a state detection unit 1027, and a power storage element 1028.

The power generation unit 1021 is constituted of a vibration- or motion-powered generator (electrostatic type, electromagnetic type, inverse magnetostriction type, piezoelectric type) that performs power generation by vibration, a solar battery power generation element that performs power generation by sunlight, an ultraviolet-light power generation element that performs power generation by ultraviolet light, an infrared-light power generation element that performs power generation by infrared light, a thermoelectric conversion element that performs power generation by difference in temperature (including power generation by Seebeck effect, Thomson effect, or the like, power generation by thermionic element or pyroelectric effect, thermomagnetic power generation, etc.), an enzyme battery that performs power generation by sweating of a living matter such as human (power generation element that uses an enzyme reaction to perform power generation), a power generation element by ion concentration difference, a power generation element that performs power generation by radiation, a radio-wave power generation element that uses radio waves (distant electromagnetic field) to induce electric power, a power generation element using a near electromagnetic field, which induces electric power by an electromagnetic field in a neighboring region and includes electromagnetic induction and electrostatic induction, an electric power transmission apparatus that uses magnetic field resonance, electromagnetic induction, or electric field coupling, or the like.

The rectification circuit unit 1022 rectifies a current generated in the power generation unit 1021. Further, the regulator 1023 increases or decreases a voltage such that a voltage obtained after the rectification has a level appropriate to the power storage. The obtained direct voltage is then supplied to the power storage element 1028, so that power storage is performed. Further, power storage of the power storage element 1028 may be performed using electric power obtained from a commercial power supply via the power supply plug unit 1024 as an alternative means of the power generation unit 1021 that obtains electric power by power generation. The power storage element 1028 is constituted of, for example, a capacitor, a secondary battery, a spiral spring, and a heat storage material, and stores electric power generated in the power generation unit 1021 or stores electric power as energy.

Further, the power generation apparatus 1020 may include the state detection unit 1027 as optional constituent element. The state detection unit 1027 includes a gyro sensor, an acceleration sensor, a velocity sensor, a GPS sensor, a temperature sensor, a humidity sensor, a radiation sensor, an illuminance sensor, an infrared sensor, a pressure sensor, a geomagnetism sensor, a Doppler sensor, a gas sensor, a camera, or the like, and acquires state information such as a posture, position, or surrounding environment of the power generation apparatus 1020.

The computing unit 1025 performs charge/discharge control of the power storage element 1028. Further, the computing unit 1025 monitors the amount of power storage of the power storage element 1028 by a voltage between both ends, a charge current, or the like of the power storage element 1028. Further, in addition to monitoring of the amount of power storage, the computing unit 1025 detects whether the amount of power storage of the power storage element 1028 is a threshold value or less or whether the power storage element 1028 is fully charged or not, and calculates an estimated time that elapses until the power storage element 1028 reaches the full charge. Further, the computing unit 1025 may monitor the amount of power generation of the power generation apparatus 1020 by monitoring a change in voltage between both ends of a capacitor (not shown) within the rectification circuit unit 1022.

The communication unit 1026 performs data communication with the image display apparatus 1010. For example, the primary information, which is basic data on power generation such as the amount of power storage or the amount of power generation acquired in the computing unit 1025, is described in the predetermined format (described above) and sent to the image display apparatus 1010 via the communication unit 1026. The information to be sent can contain an estimated time that elapses until the power storage element 1028 reaches the full charge, in addition to the primary information on the amount of power storage or the amount of power generation. Further, the state information detected by the state detection unit 1027 is sent to the image display apparatus 1010 via the communication unit 1026 as necessary.

Meanwhile, in the image display apparatus 1010, a power supply unit 1101 is constituted of a secondary battery or the like and supplies drive power to units of the image display apparatus 1010. The secondary battery of the power supply unit 1101 is compatible with, for example, a secondary battery serving as the power storage element 1028.

A power supply management unit 1102 manages the power supply of the image display apparatus 1010. For example, the power supply management unit 1102 manages the remaining amount or operation time of the secondary battery used in the power supply unit 1101 and a time of replacement of the secondary battery being used.

A computing unit 1103 performs computing processing on the primary information, which is the basic data on the power generation received from the power generation apparatus 10210 via the communication unit 1205. The computing unit 1103 controls display and output of a processing result to a display unit 1209.

The computing unit 1103 executes a program for processing the power generation information, for example, and converts the amount of power generation, which is the primary information obtained from the power generation apparatus 1020, into secondary information on the basis of the principle that the power generation unit induces electric power. The secondary information includes user monitoring information such as the amount of exercise of the user, and environment monitoring information such as ultraviolet light intensity and radio field intensity. The secondary information is output to the display unit 1209 and an outer display unit 1215 for display, so that monitoring of the user him/herself or monitoring of the surrounding environment are achieved.

When converting and computing the amount of power generation, for example, the computing unit 1103 uses detection information by a posture/position detection unit 1204, a state detection unit 1211, or an environmental sensor 1216. Further, a captured image of an outer camera 1212 may be input as appropriate and used for processing of displaying the monitoring information.

Further, the computing unit 1103 may store the primary information such as the amount of power generation received from the power generation apparatus 1020, the secondary information such as the user monitoring information or environment monitoring information converted from the primary information, a displayed image of the primary information or secondary information output to the display unit 1209 or outer display unit 1215 or display, and the like in a storage unit 1206 as necessary or may transfer those information to the outside via the communication unit 1205.

Furthermore, the computing unit 1103 may display the displayed image, which is the same as that displayed on the display unit 1209, on the outer display unit 1215 and present (release) the primary information such as the amount of power generation received from the power generation apparatus 1020, and the secondary information such as the user monitoring information or environment monitoring information converted from the primary information, to people around the user.

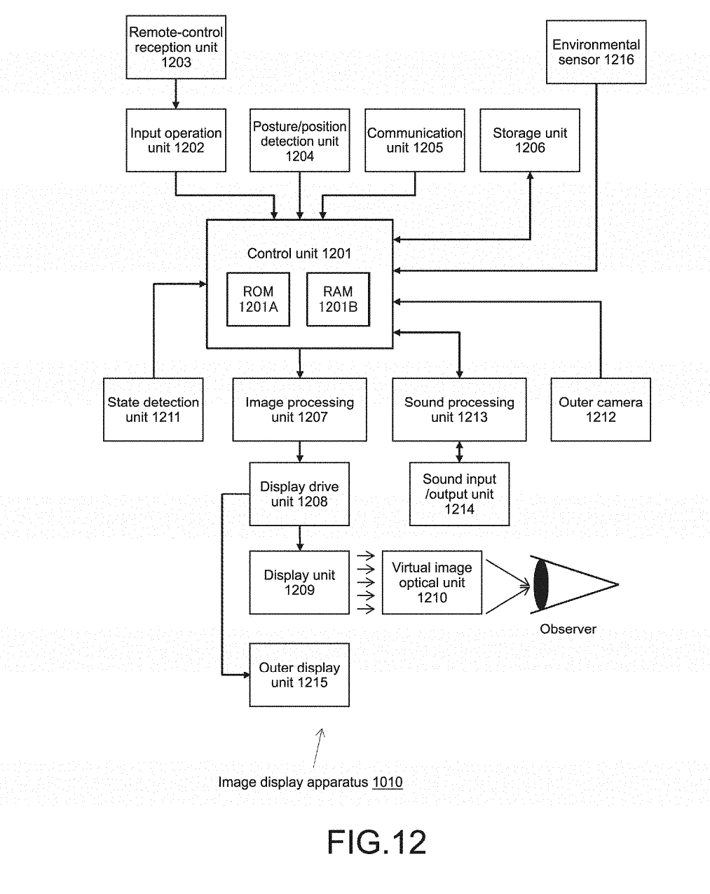

FIG. 12 shows an internal configuration example of a head mounted display as the image display apparatus 1010.

A control unit 1201 includes a ROM (Read Only Memory) 1201A and a RAM (Random Access Memory) 1201B. The ROM 1201A stores program codes executed by the control unit 1201 and various types of data. The control unit 1201 executes a program loaded to the RAM 1201B, and thus starts image display control and integrally controls the overall operation of the image display apparatus 1010. Examples of the program codes and various types of data include a program for processing information acquired from the power generation apparatus (described above) provided outside the image display apparatus 1010 and unique identification information of the apparatus 1010.

An input operation unit 1202 includes one or more operating elements such as a key, a button, and a switch, with which the user performs an input operation. The input operation unit 1202 receives a user instruction via the operating element and outputs the user instruction to the control unit 1201. Further, the input operation unit 1202 similarly receives a user instruction, which is formed of a remote-control command received in a remote-control reception unit 1203, and outputs the user instruction to the control unit 1201.

The posture/position detection unit 1204 is a unit that detects a posture or a position of the head of the user wearing the image processing apparatus 1010. The posture/position detection unit 1204 is constituted of any one of a gyro sensor, an acceleration sensor, a GPS (Global Positioning System) sensor, a geomagnetism sensor, a Doppler sensor, an infrared sensor, a radio field intensity sensor, and the like, or constituted by combination of two or more sensors in consideration of advantages and disadvantages of the respective sensors.

The state detection unit 1211 acquires state information on a status of the user wearing the image display apparatus 1010 and outputs the state information to the control unit 1201. As the state information, for example, a working state of the user (presence or absence of the mounting of the image display apparatus 1010), a behavior state of the user (moving state such as at rest, walking, and running, open/close state of eyelids, eye direction, size of pupil), a mental state (level of sensation, level of excitement, level of awareness, affect, and emotion, such as whether the user is immersing him/herself in or concentrating on observation of displayed image), and also a physiological state are acquired. Further, in order to acquire those pieces of state information from the user, the state detection unit 1211 may include various state sensors (not shown in the figure) such as a mounting sensor formed of a mechanical switch or the like, an inner camera that captures an image of the face of the user, a gyro sensor, an acceleration sensor, a velocity sensor, a pressure sensor, a body temperature sensor, a sweating sensor, a myoelectric potential sensor, an ocular potential sensor, a brain wave sensor, a breath sensor, a gas sensor, and an ion concentration sensor.

The environmental sensor 1216 is formed of various sensors that measure information on the environment of the image display apparatus 1010. For example, the environmental sensor 1216 includes an acceleration sensor that will be described later, an electromagnetic wave sensor, a geomagnetism sensor, a water flow sensor, an airflow sensor, a light sensor, a temperature sensor, an illuminance sensor, and the like.

The outer camera 1212 is disposed almost at the center of the front surface of the main body of the image display apparatus 1010 having the form of eyeglasses, for example, and can capture an image of surroundings. Further, posture control in pan, tilt, and roll directions of the outer camera 1212 is performed according to the eye direction of the user that is detected by the state detection unit 1211, so that an image of the user's line of sight, i.e., an image in the eye direction of the user can be captured with the outer camera 1212. It is more desirable to configure the outer camera 1212 by a plurality of cameras so as to acquire three-dimensional information of the image of surroundings by using parallax information. The user can adjust zooming of the outer camera 512 according to an operation of the input operation unit 1202, the size of pupil recognized on the basis of a captured image of an inner camera (not shown) or the like, or an instruction input through voice. The captured image of the outer camera 1212 can be output to the display unit 1209 for display, and also stored in the storage unit 1206.

The communication unit 1205 performs communication processing with an external device such as the power generation apparatus (described above) and performs modulation and demodulation processing and encoding and decoding processing on communication signals. Further, the control unit 1201 sends data, which is to be sent to the external device, from the communication unit 1205.

The storage unit 1206 is a large-capacity storage apparatus constituted of an SSD (Solid State Drive) or the like. The storage unit 1206 stores application programs executed by the control unit 1201 and various types of data. As the data to be stored, a captured image by the outer camera 1212 (described later), image content reproduced and displayed on the display unit 1209 (described later), information received from the power generation apparatus (described above), and the like can be exemplified.

An image processing unit 1207 further performs signal processing such as image quality correction on an image signal output from the control unit 1201, and converts resolution of the image signal into resolution conforming to the screen of the display unit 1209. A display drive unit 1208 sequentially selects pixels of the display unit 1209 on a row-by-row basis, line-sequentially scans the pixels, and supplies a pixel signal based on the image signal that has been subjected to the signal processing.

The display unit 1209 includes a display panel constituted of, for example, a micro-display such as an organic EL (Electro-Luminescence) element or a liquid crystal display, or a laser-scanning display such as retina direct drawing display. A virtual image optical unit 1210 enlarges and projects the displayed image of the display unit 1209 to cause the user to observe the image as an enlarged virtual image.

The outer display unit 1215 has a display screen facing the outside of the image display apparatus 1010 (the opposite direction of the face of the user wearing the image display apparatus 1010) and can display an image for another user, the image being the same as or different from the image of the display unit 1209 (see, for example, Patent Literature 8).

A sound processing unit 1213 performs sound quality correction or sound amplification on a sound signal output from the control unit 1201 and further performs signal processing for the input sound signal and the like. A sound input/output unit 1214 outputs the sound obtained after the sound processing to the outside, and inputs sounds from a microphone (described above).

### INDUSTRIAL APPLICABILITY

Hereinabove, the technology disclosed in this specification has been described in detail with reference to the specific embodiment. However, it is obvious that modifications and substitutions can be made to the embodiment by those skilled in the art without departing from the gist of the technology disclosed in this specification.

The technology disclosed in this specification provides a unified format of a message to various power generation devices or power storage devices, which may be connected to various apparatuses for outdoor use that cannot use a commercial power supply, such as portable electronic apparatuses, the message transmitting information on a power generation efficiency and other power generation statuses, and the remaining amount, a power storage efficiency, and other power storage statuses of the secondary battery. Therefore, the electronic apparatus, which uses electric power from the power generation devices or power storage devices, can receive the message from any of the power generation devices or power storage devices, analyze content thereof, and further present it to the user.

Further, as the electronic apparatus that uses electric power from the power generation devices or power storage devices, a head mounted display, multifunctional portable terminals such as a smartphone and a tablet, a personal computer, a digital camera, a digital video camera, an electronic book, a portable music player, a game machine, a watch, a watch-type electronic apparatus, a sports sensor, a controller thereof, and the like are exemplified. Additionally, the technology disclosed in this specification can also be applied to various mobile apparatuses that use electric power, such as a two-wheel electric motor vehicle, an electrical vehicle, and a hybrid vehicle.

In short, the technology disclosed in this specification has been described as an illustrative embodiment, and the details described in this specification should not be construed as limiting. To determine the gist of the technology disclosed in this specification, the Claims should be considered.

It should be noted that the technology disclosed in this specification can have the following configurations.

(1) An information transmission apparatus, including:

an information acquisition unit that acquires power generation/power storage information of a power generation unit or a power storage unit;

a message generation unit that generates a message having the predetermined format containing the power generation/power storage information; and

a communication unit that transmits the message.

(2) The information transmission apparatus according to (1), further including

a power generation unit or a power storage unit, in which

the information acquisition unit monitors the power generation unit or the power storage unit and acquires power generation/power storage information.

(3) An information transmission apparatus, including:

a communication unit that receives a message having a predetermined format containing power generation/power storage information of a power generation unit or a power storage unit; and

an information analysis unit that analyzes the received message.

(4) The information transmission apparatus according to (3), further including:

a presentation unit; and

a presentation control unit that controls the presentation unit to present the power generation/power storage information on the basis of an analysis result by the information analysis unit.

(5) The information transmission apparatus according to (4), in which

when the received message contains power generation information and power storage information, the presentation control unit controls the presentation unit to present the power generation information and the power storage information,

when the received message contains only the power generation information, the presentation control unit controls the presentation unit to present the power generation information, and

when the received message contains only the power storage information, the presentation control unit controls the presentation unit to present the power storage information.

(6) The information transmission apparatus according to (4), in which

when pieces of power generation/power storage information are received, the presentation control unit adds the pieces of power generation/power storage information and controls the presentation unit to present a result.

(7) The information transmission apparatus according to (4), in which

when pieces of power generation/power storage information are received, the presentation control unit normalizes each of the pieces of power generation/power storage information by the maximum or prescribed generated electric power or by the amount of generated electric power or a charging capacity, and controls the presentation unit to present a result.

(8) The information transmission apparatus according to (4), in which

when pieces of power generation/power storage information are received, the presentation control unit presents a list of the pieces of power generation/power storage information, or selects one of the pieces of power generation/power storage information and presents the selected piece of power generation/power storage information.

(9) An information transmission method, including:

an information acquisition step of acquiring power generation/power storage information of a power generation unit or a power storage unit;

a message generation step of generating a message having the predetermined format containing the power generation/power storage information; and

a communication step of transmitting the message.

(10) An information transmission method, including:

a communication step of receiving a message having a predetermined format containing power generation/power storage information of a power generation unit or a power storage unit; and

an information analysis step of analyzing the received message.

### REFERENCE SIGNS LIST

100 information transmission system
200 information sending apparatus
201 power generation unit
202 power storage unit
203 monitoring unit
204 information generation unit
205 communication unit
300 information receiving apparatus
301 communication unit
302 information analysis unit
303 presentation control unit
304 presentation unit
1001, 1002 shoe
1010 image display apparatus (head mounted display)
1011, 1012 display unit
1020, 1030 power generation apparatus
1021 power generation unit
1022 rectification circuit unit
1023 regulator
1024 power supply plug unit
1025 computing unit
1026 communication unit
1027 state detection unit
1028 power storage element
1101 power supply unit
1102 power supply management unit
1103 computing unit
1201 control unit
1201A ROM
1201B RAM
1202 input operation unit
1203 remote-control reception unit
1204 posture/position detection unit
1205 communication unit
1206 storage unit
1207 image processing unit
1208 display drive unit
1209 display unit
1210 virtual image optical unit
1211 state detection unit
1212 outer camera
1213 sound processing unit
1214 sound input/output unit
1215 outer display unit
1216 environmental sensor

1. An information transmission apparatus, comprising:
an information acquisition unit that acquires power generation/power storage information of a power generation unit or a power storage unit;
a message generation unit that generates a message having the predetermined format containing the power generation/power storage information; and
a communication unit that transmits the message.

2. The information transmission apparatus according to claim 1, further comprising
a power generation unit or a power storage unit, wherein
the information acquisition unit monitors the power generation unit or the power storage unit and acquires power generation/power storage information.

3. An information transmission apparatus, comprising:
a communication unit that receives a message having a predetermined format containing power generation/power storage information of a power generation unit or a power storage unit; and
an information analysis unit that analyzes the received message.

4. The information transmission apparatus according to claim 3, further comprising:
a presentation unit; and
a presentation control unit that controls the presentation unit to present the power generation/power storage information on the basis of an analysis result by the information analysis unit.

5. The information transmission apparatus according to claim 4, wherein
when the received message contains power generation information and power storage information, the presentation control unit controls the presentation unit to present the power generation information and the power storage information,
when the received message contains only the power generation information, the presentation control unit controls the presentation unit to present the power generation information, and
when the received message contains only the power storage information, the presentation control unit controls the presentation unit to present the power storage information.

6. The information transmission apparatus according to claim 4, wherein
when pieces of power generation/power storage information are received, the presentation control unit adds the pieces of power generation/power storage information and controls the presentation unit to present a result.

7. The information transmission apparatus according to claim 4, wherein
when pieces of power generation/power storage information are received, the presentation control unit normalizes each of the pieces of power generation/power storage information by the maximum or prescribed generated electric power or by the amount of generated electric power or a charging capacity, and controls the presentation unit to present a result.

8. The information transmission apparatus according to claim 4, wherein
when pieces of power generation/power storage information are received, the presentation control unit presents a list of the pieces of power generation/power storage information, or selects one of the pieces of power generation/power storage information and presents the selected piece of power generation/power storage information.

9. An information transmission method, comprising:
an information acquisition step of acquiring power generation/power storage information of a power generation unit or a power storage unit;
a message generation step of generating a message having the predetermined format containing the power generation/power storage information; and
a communication step of transmitting the message.

10. An information transmission method, comprising:
a communication step of receiving a message having a predetermined format containing power generation/power storage information of a power generation unit or a power storage unit; and
an information analysis step of analyzing the received message.
